(19) United States
(12) Patent Application Publication
(10) Pub. No.: US 2014/0272881 A1
(43) Pub. Date: Sep. 18, 2014

(54) METHOD OF PRODUCING A PATIENT-SPECIFIC THREE DIMENSIONAL MODEL HAVING HARD TISSUE AND SOFT TISSUE PORTIONS

(71) Applicant: THE CLEVELAND CLINIC FOUNDATION, Cleveland, OH (US)

(72) Inventor: Wael K. Barsoum, Bay Village, OH (US)

(73) Assignee: THE CLEVELAND CLINIC FOUNDATION, Cleveland, OH (US)

(21) Appl. No.: 14/202,428

(22) Filed: Mar. 10, 2014

Related U.S. Application Data
(60) Provisional application No. 61/781,060, filed on Mar. 14, 2013.

(51) Int. Cl. G09B 23/30

(52) U.S. Cl. CPC G09B 23/30
USPC 434/274; 29/428

(57) ABSTRACT

A method of producing a patient-specific three-dimensional model of a native tissue. A virtual replica of at least a portion of a native tissue is produced. A three-dimensional unitary replica of the portion of the native tissue is produced as a tangible representation of the virtual replica. The three-dimensional unitary replica includes at least one location of interest. The three-dimensional unitary replica includes a first area and a second area of the portion of the native tissue. The first area density has a first area density greater than a second area density of the second area.

### RELATED APPLICATION

This application claims priority from U.S. Provisional Application No. 61/781,060, filed 14 Mar. 2013, the subject matter of which is incorporated herein by reference in its entirety.

### TECHNICAL FIELD

The present invention relates generally to a device to prepare for surgery and, more particularly, to a method of producing a patient-specific three-dimensional model of a portion of native tissue.

### BACKGROUND

The spine is a complex anatomical structure that provides protection for the spinal cord and support for a patient. The spine includes both hard tissue portions (e.g., vertebral bodies, pedicles, and processes) and soft tissue portions (e.g., intervertebral disks, nerves, ligaments, and connecting tissue). Due to the varying forces and pressures exerted on the spine, a surgical procedure may be helpful to restore structural stability of an injured spine.

Spinal surgical procedures are often used to treat the patient and restore at least a portion of spinal stability. Due to the complex nature of the spine and for the health of the patient, minimally invasive spinal procedures may be desirable in some patients. Thus, it is important for a surgeon to determine a specific portion of the spine that needs a surgical procedure. To resolve this problem, physical models of the spine that reflect the physical characteristics of the spine of the patient are created.

### SUMMARY

In an embodiment of the present invention, a method of producing a patient-specific three-dimensional model of a native tissue is disclosed. A virtual replica of at least a portion of a native tissue is produced. A three-dimensional unitary replica of the portion of the native tissue is produced as a tangible representation of the virtual replica. The three-dimensional unitary replica includes at least one location of interest. The three-dimensional unitary replica includes a first area and a second area of the portion of the native tissue. The first area density has a first area density greater than a second area density of the second area.

In an embodiment of the present invention, a method of producing a three-dimensional model of a spine and assisting a user with implementation of a preoperative surgical plan is disclosed. Images of at least a portion of the spine are obtained. A virtual replica is produced as an intangible representation of the images. A three-dimensional replica is produced as a tangible representation of the virtual replica. The three-dimensional replica includes at least one location of interest. The three-dimensional replica includes a first area that included at least one of vertebral bodies, pedicles, and spinal processes. A second area includes at least one of intervertebral disks, spinal nerves, spinal ligaments, and connecting tissue of the spine. The first area has a first area density greater than a second area density of the second area. The three-dimensional replica reflects at least one of patient-specific flexibility and patient-specific movement relative to another portion of the spine. At least one non-native structure is associated with the at least one location of interest. Realistic dynamic reactions are induced in the physical replica. Alterations to the physical replica in response to the induced reactions are analyzed.

In an embodiment of the present invention, a three-dimensional patient-specific model of tissue of at least a portion of a spine is disclosed. The three dimensional patient-specific model includes at least one location of interest. The three dimensional patient-specific model also includes a first area and a second area of the portion of the native tissue. The first area has a first area density greater than a second area density of the second area. The three dimensional patient-specific model is a tangible representation of at least a portion of native tissue. The three dimensional patient-specific model is unitarily formed.

### BRIEF DESCRIPTION OF THE DRAWINGS

The foregoing and other features of the present invention will become apparent to those skilled in the art to which the present invention relates upon reading the following description with reference to the accompanying drawings, in which:

FIGS. 1A-C are side views showing a model of a spine;

FIG. 2 is a top view of the model of FIGS. 1A-C; and

FIG. 3 is a flow chart showing an example process of producing the model of FIGS. 1A-C.

### DETAILED DESCRIPTION

The present invention relates generally to a device to prepare for surgery and, more particularly, to a method of producing a patient-specific three-dimensional model. Although the present invention is described below primarily in terms of a spinal procedure, it will be appreciated that the three-dimensional model can be used during any surgical procedure (e.g., procedures for a shoulder, knee, neck, hip, ankle, phalangeal, metacarpal, metatarsal, defects of long bones, muscles, tendons, ligaments, cartilage, etc.), or to help a user visualize patient tissue for a non-surgical reason. According to an aspect of the present invention, FIGS. 1A-C illustrate a three-dimensional model 10 of a portion of a native tissue used to prepare for a surgical procedure. As used herein, the term “native tissue” (and variants thereof) refers to a portion of the patient's spine that is of interest in its condition at the time of surgical preparation, having any included natural or artificial structures of interest, whether congenital or acquired. Specifically, the term “native tissue” refers herein to one or more portions of hard and soft tissues of the patient's spine. However, it will be appreciated that the three-dimensional model 10 can be used in connection with any portion of native tissue of the patient (e.g., arm, shoulder, metacarpal, leg, knee, hip, ankle, metatarsal, phalange, neck, or the like.). It will also be appreciated that the three-dimensional model 10 can be used in connection with any portion of hard tissue portions (e.g. bone, or the like) or soft tissue portions (e.g., muscle, tendon, ligament, cartilage, or the like) of the native tissue.

In accordance with the present invention, FIGS. 1A-C show side views of the three-dimensional model 10 of the native tissue (i.e., the spine). The three-dimensional model 10 can be a physical model of the native tissue. As used herein, the term “physical model” refers to a replica or copy of a physical item at any relative scale. The physical model is produced as a tangible representation of a virtual model of the native tissue, as described herein. As used herein, the term “virtual model” refers to indicate a virtual replica or copy of an actual or physical item, at any relative scale. The three-dimensional model 10 can be unitarily formed. As used herein, the term “unitary” (and variants thereof) refers to the configuration of the three-dimensional model 10 as being a singular structure. In one instance, the three-dimensional model 10 can be created as a whole, one-piece structure. In another instance, the three-dimensional model 10 can be assembled from at least two portions of a physical model (e.g., first and second halves of the spine, one or more vertebrae of the spine, etc.).

To allow a user to determine the effects of surgery on the native tissue of the patient, the three-dimensional model 10 reflects at least one patient-specific physical characteristic of the native tissue (e.g., flexibility, movement relative to a portion of the native tissue, density of bone, etc.). As used herein, the term “surrounding tissue” is used to refer to tissue that surrounds the spine (e.g., muscle, nerve, and the like) or tissue that surrounds one or more vertebrae (e.g. another vertebra(e)). The three-dimensional model 10 portrays physical characteristics of the particular patient's spine relative to the surrounding tissue. The three-dimensional model 10 can be used to study the particular patient's tissue and simulate effects of surgery on the patient's native tissue. The three dimensional model 10 is configured to respond to applied stimuli for a user to study and analyze the native tissue in response to the applied stimuli. The user may then anticipate the effects of surgery on the native tissue based on the response of the three-dimensional model 10 to the applied stimuli.

As shown in FIG. 2, the three dimensional model 10 includes a first area 12 of the native tissue and a second area 14 of the native tissue. The first area 12 is substantially made of a first material and the second area 14 is substantially made of a second material that is different from the first material. In one example, the first area 12 can be made of a hard plastic (e.g., polyurethane, etc.). In another example, the second area 14 can be made of a soft plastic (e.g., polyethylene, polypropylene, polyvinyl chloride, etc.). The first area 12 has a first area density that is greater than a second area density of the second area 14. The first and second areas 12 and 14 are anatomically differentiated from one another. As used herein, the term “anatomically differentiated” (and variants thereof) is used to refer to each portion of the three-dimensional model 10 having individual distinctions in anatomy. In particular, each vertebra of the three-dimensional model 10 is anatomically differentiated from every other vertebrae of the three-dimensional model. In one example, the first area 12 of the native tissue can include at least one hard tissue portion of the native tissue (e.g., vertebral bodies, pedicles, and spinal processes of a spine). In another example, the second area 14 of the native tissue can include at least one soft tissue portion of the native tissue (e.g., intervertebral disk, nerves, ligaments, and connecting tissue of a spine).

The three-dimensional model 10 has at least one location of interest 16. As used herein, the term “location of interest” refers to a surface of the three dimensional model 10 which the user wishes to study and manipulate. As one of ordinary skill in the art will be aware, a location of interest 16 in most cases will not have clearly defined borders, but that person of ordinary skill in the art will be able to instinctively differentiate between a location of interest and another portion of the native tissue, which is not a location of interest, for a particular application of the present invention. As shown, the location of interest 16 can be located on a pedicle, process, vertebral body, or intervertebral disk of the patient's spine. The location of interest 16 may be a portion (e.g., pedicles, intervertebral disks, etc.) of the native tissue on which a surgeon desires to perform a surgical procedure (e.g., discectomy, spinal fusion, and the like).

At least one non-native structure 18 is associated with the three dimensional model 10. As used herein, the term “non-native structure” refers to any two-dimensional or three-dimensional structure not made of native tissue, which serves as a user-perceivable portion of the three dimensional model 10. As shown, a non-native structure 18 is installed at a single example location of interest 16; however, it will be appreciated that a non-native structure may be installed at each location of interest. The non-native structures 18 discussed with respect to the present invention are presumed to be affixed or otherwise rigidly associated with the native tissue so that a user can confidently maintain a sense of physical and/or visual orientation within the operative field. As shown, the non-native structure 18 is a guide pin. However, it will be appreciated that suitable non-native structures 18 may include, but are not limited to, visual “written” marks (e.g., a thin layer of a substance left behind after contact with a crayon, surgical pen, or the like), other written marks outside the visual spectrum (e.g., a UV-fluorescent paint), guide pins, fasteners (e.g., screws, nails, staples, or the like), radioactive tags, bovie cautery burn marks, bosses (protrusions) or cavities formed in the material of the three dimensional model 10, metallic or nonmetallic devices attached to the desired location of interest (e.g., a rivet, tack, or the like), modifications of the native tissue itself (e.g., notches, inscribed lines, drill holes, or the like), or any other non-native construct or feature.

The location and trajectory/orientation of each non-native structure 18 on the three dimensional model 10 may be predetermined by a user before the non-native structure is associated with the three dimensional model. This predetermination may occur intraoperatively, while the user is able to directly see the condition of the surgical site and associate the non-native structure 18 with the corresponding location of interest 16 accordingly. However, it is also contemplated that a predetermination of the desired location and desired trajectory for each non-native structure 18 could be accomplished preoperatively, with reference to preoperative imaging of the native tissue. Using preoperative planning software or tools and/or any other planning means (e.g., “dead reckoning”, “eyeballing”, or other non-planned or non-assisted placement methods), a user can create the three dimensional model 10 for observation, manipulation, rehearsal, or any other pre-operative tasks, the three-dimensional model having any number and type of non-native structures 18 associated therewith, for any reason(s). The non-native structure 18 can be an information feature providing clinically useful information to a user. As used herein, the term “clinically useful information” refers to any information, other than the structure of the native tissue itself, that assists one of ordinary skill in the art with some pre- and/or intra-operative task.

As shown in FIG. 3, the three-dimensional model 10 can be created to reflect the native tissue to help a user simulate effects of alterations to the native tissue according to an example process shown in flowchart 300. The first and second areas 12 and 14 of the three-dimensional model 10 help a user to study the particular patient's spinal anatomy in response to manipulations of the model. To create the three-dimensional model 10 as described in a first action block 301 of the flowchart 300, a user obtains images of the patient's native tissue. In one example, a surgeon takes one or more dynamic X-ray images of the native tissue (e.g., the patient's spine) to obtain views (e.g., orthogonal views) of the patient's spine. The dynamic X-rays are used to capture a variety of images of the spine while the patient is in one or more predetermined positions (e.g., the patient standing up, lying down, bending forward, etc.). The surgeon uses the dynamic X-ray images to study how the patient's spine reacts while in different positions. The dynamic X-rays images can be used to create the three-dimensional model 10 and/or predict responses of the patient's spine to applied forces. It will be appreciated that the images may also or instead be obtained from digital or analog radiography, magnetic resonance imaging, or any other suitable imaging means.

A virtual replica of the three-dimensional model 10 is produced as an intangible representation of the obtained images. The images are used to produce the virtual replica of the three-dimensional model 10 of the native tissue, as described in a second action block 302 of the flowchart 300. The virtual replica may be based upon, for example, scanned image data taken from an imaging scan of the native tissue. For example, and as presumed in the below description, the virtual replica may be based upon computer tomography data imported into a computer aided drafting system. Additionally or alternatively, the virtual replica may be based upon digital or analog radiography, magnetic resonance imaging, or any other suitable imaging means. The virtual replica will generally be displayed for the user to review and manipulate preoperatively, such as through the use of a computer or other graphical workstation interface. While this description presumes a three-dimensional model, one of ordinary skill in the art could use a two-dimensional model in a similar manner to that shown and described herein, without harm to the present invention. The virtual replica of the three dimensional model 10 may be displayed on a computer for automatic and/or manual virtual manipulation by a user.

A physical replica of the three-dimensional model 10 is produced as a tangible representation of the virtual replica. A physical replica of the three-dimensional model 10 is created from the virtual replica of the three-dimensional model in any suitable manner, as described in a third action block 303 of the flowchart 300. The physical replica of the three dimensional model 10 may be created as a one-piece of multi-component structure, and by any suitable method (e.g., selective laser sintering [“SLS”], fused deposition modeling [“FDM”], stereolithography [“SLA”], laminated object manufacturing [“LOM”], electron beam melting [“EBM”], 3-dimensional printing [“3DP”], contour milling from a suitable material, computer numeric control [“CNC”], other rapid prototyping methods, or any other desired manufacturing process). The physical replica of the three-dimensional model 10 includes the first area 12 and the second area 14. The first area 12 of the spine includes the hard tissue portions of the spine (e.g., vertebral bodies, pedicles, and spinal processes of a spine). The second area 14 of the spine includes the soft tissue portions of the native tissue (e.g., intervertebral disk, nerves, ligaments, and connecting tissue). To finish assembly of the physical replica, a fourth action block 304 of the flowchart 300 describes that the non-native structure 18 is associated with one or more locations of interest 16 on the physical replica. The non-native structures 18 are affixed or otherwise rigidly associated with locations of interest 16 the native tissue. As shown, the non-native structure 18 is a guide pin.

Once created, the physical replica of the three dimensional model 10 may be used to help a user create a pre- or intra-operative surgical plan. Specifically, as described in a fifth action block 305 of the flowchart 300, a user can induce realistic dynamic reactions in the three dimensional model 10 using applied forces, and analyze alterations to the three dimensional model in response to the induced reactions. As used herein, the term “realistic dynamic reaction” refers to a physical manipulation or change of the three dimensional model 10 responsive to an application of force caused by the user. A realistic dynamic reaction can include: twisting, pulling, cutting, drilling, or any other physical manipulation of the three dimensional model 10 responsive to force applied, manually or automatically, by the user. The user observes the alterations to the three dimensional model 10, as a form of clinically useful information. The realistic dynamic reactions may be induced at or near the locations of interest 16, optionally via forces applied to one or more corresponding non-native structures. In one example, the user can drill an opening into a pedicle of the three dimensional model 10 to determine how the three dimensional model, and thus the native tissue of the patient, physically responds during and after the drilling, and optionally a response to an implanted structure placed through use of the drilled hole. In another example, the user can twist and pull the three dimensional model 10 to see how the three dimensional model, and by extension, the native tissue of the patient, responds, or would likely respond, to the twisting and pulling of a spinal straightening procedure, the reduction of a slipped vertebrae, or the like.

Alternatively, the user can manipulate the virtual replica of the three dimensional model 10 to invoke a realistic dynamic reaction in the related physical replica of the three-dimensional model. The virtual replica can be manipulated with a computer program that also controls a robotic arm or other haptic device so that a manipulation of the virtual replica by the computer program causes an application of forces that induce a corresponding realistic dynamic reaction in the three dimensional model 10. The realistic dynamic reactions may be induced at the locations of interest 16 on the virtual replica. In one example, the non-native structure 18 can be used to induce a realistic dynamic reaction in the virtual replica for example, a protruding guide pin could be grasped and manipulated to transfer a force to the physical replica. The non-native structure 18 can include, or be associated with a transducer or other device in electronic communication with the computer program to allow manipulation of the virtual model of the three dimensional model 10. The user can use the computer program to realistic dynamic responses on the locations of interest 16 on the physical replica. A force can be virtually applied to the virtual replica so that the computer and the haptic device apply the same force to the physical replica. The transducer or other device associated with the non-native structure 18 causes a corresponding realistic dynamic response on the location of interest 16 on the physical replica.

The alterations to the three dimensional model 10 comprise clinically useful information. The resulting realistic dynamic reactions of the three dimensional model 10 comprise clinically useful information, which can be collected by the user for use during a surgical procedure, as described in a sixth action block 306 of the flowchart 300. The user can observe and collect the clinically useful information for use, for example, in surgery on the patient, as described in a seventh action block 307 of the flowchart 300. In one example, when the realistic dynamic responses are induced in the physical model of the three dimensional model 10, the user can sense the alterations to the physical model. The alterations to the physical model comprise the clinically useful information for use in the surgical procedure. In another example, when the realistic dynamic responses are induced in the physical model of the three dimensional model 10, the computer program can record the corresponding alterations to the physical model, which the user can later recall, for example, during a surgical procedure.

While aspects of the present invention have been particularly shown and described with reference to the preferred embodiment above, it will be understood by those of ordinary skill in the art that various additional embodiments may be contemplated without departing from the spirit and scope of the present invention. For example, the specific methods described above for using the described system are merely illustrative; one of ordinary skill in the art could readily determine any number of tools, sequences of steps, or other means/options for virtually or actually placing the above-described apparatus, or components thereof, into positions substantially similar to those shown and described herein. Any of the described structures and components could be integrally formed as a single piece or made up of separate sub-components, with either of these formations involving any suitable stock or bespoke components and/or any suitable material or combinations of materials; however, the chosen material(s) should be biocompatible for most applications of the present invention. The mating relationships formed between the described structures need not keep the entirety of each of the “mating” surfaces in direct contact with each other but could include spacers or holdaways for partial direct contact, a liner or other intermediate member for indirect contact, or could even be approximated with intervening space remaining therebetween and no contact. Though certain components described herein are shown as having specific geometric shapes, all structures of the present invention may have any suitable shapes, sizes, configurations, relative relationships, cross-sectional areas, or any other physical characteristics as desirable for a particular application of the present invention. Any structures or features described with reference to one embodiment or configuration of the present invention could be provided, singly or in combination with other structures or features, to any other embodiment or configuration, as it would be impractical to describe each of the embodiments and configurations discussed herein as having all of the options discussed with respect to all of the other embodiments and configurations. The system is described herein as being used to plan and/or simulate a surgical procedure of implanting one or more prosthetic structures into a patient's body, but also or instead could be used to plan and/or simulate any surgical procedure, regardless of whether a non-native component is left in the patient's body after the procedure. A device or method incorporating any of these features should be understood to fall under the scope of the present invention as determined based upon the claims below and any equivalents thereof.

Other aspects, objects, and advantages of the present invention can be obtained from a study of the drawings, the disclosure, and the appended claims.

Having described the invention, we claim:

1. A method of producing a patient-specific three-dimensional model of a native tissue, the method comprising the steps of:
producing a virtual replica of at least a portion of a native tissue; and
producing a three-dimensional unitary replica of the portion of the native tissue as a tangible representation of the virtual replica, the three-dimensional unitary replica including at least one location of interest, the three-dimensional unitary replica including a first area and a second area of the portion of the native tissue, the first area density having a first area density greater than a second area density of the second area.

2. The method of claim 1, wherein the first area is anatomically differentiated from the second area.

3. The method of claim 1, wherein the native tissue is at least a portion of a spine.

4. The method of claim 3, wherein the first area of the spine comprises at least one of vertebral bodies, pedicles, and spinal processes.

5. The method of claim 3, wherein the second area of the spine comprises at least one of intervertebral disks, spinal nerves, spinal ligaments, and connecting tissue.

6. The method of claim 1, wherein the first area is substantially made of a first material and the second area is substantially made of a second material that is different from the first material.

7. The method of claim 1, wherein the step of producing a virtual replica of the portion of the native tissue includes the step of obtaining images of the portion of the native tissue.

8. The method of claim 1, wherein the three-dimensional unitary replica reflects at least one of patient-specific flexibility and patient-specific movement relative to a portion of the native tissue.

9. The method of claim 1, including the step of associating at least one non-native structure with the at least one location of interest.

10. The method of claim 9, wherein the non-native structure is installed at the location of interest.

11. The method of claim 9, wherein the non-native structure is an information feature providing clinically useful information to a user.

12. The method of claim 9, wherein the non-native structure is a guide pin.

13. The method of claim 9, wherein the virtual replica, assisted by the non-native structure, is configured to induce a corresponding reaction in the three-dimensional unitary model.

14. A method of producing a three-dimensional model of a spine and assisting a user with implementation of a preoperative surgical plan, the method comprising the steps of:
obtaining images of at least a portion of the spine;
producing a virtual replica as an intangible representation of the images; and
producing a three-dimensional replica as a tangible representation of the virtual replica, the three-dimensional replica including at least one location of interest, the three-dimensional replica comprising a first area including at least one of vertebral bodies, pedicles, and spinal processes, and a second area including at least one of intervertebral disks, spinal nerves, spinal ligaments, and connecting tissue of the spine, the first area having a first area density greater than a second area density of the second area, the three-dimensional replica reflecting at least one of patient-specific flexibility and patient-specific movement relative to another portion of the spine;
associating at least one non-native structure with the at least one location of interest;
inducing realistic dynamic reactions in the physical replica; and
analyzing alterations to the physical replica in response to the induced reactions.

15. The method of claim 14, wherein the images of the portion of the spine are obtained using one or more dynamic X-rays.

16. The method of claim 14, wherein the first area is anatomically differentiated from the second area.

17. The method of claim 14, wherein the first area is made of a first material and the second area is made of a second material that is different from the first material.

18. The method of claim 14, wherein the at least one non-native structure is an information feature providing clinically useful information to a user.

19. The method of claim 14, wherein the non-native structure is a guide pin.

20. The method of claim 14, further including the step of manipulating the virtual replica to induce the realistic dynamic reactions in the physical replica using the at least one non-native structure.

21. The method of claim 14, further including the step of inducing the realistic dynamic reactions in the physical replica near the at least one location of interest.

22. The method of claim 14, wherein the at least one non-native structure is used to induce realistic dynamic reactions in the at least one location of interest.

23. The method of claim 14, including the step of using the clinically useful information obtained from applying the realistic dynamic reactions to the physical replica to operate on the native tissue during a patient procedure.

24. A three-dimensional patient-specific model of tissue of at least a portion of a spine, comprising:
at least one location of interest; and
a first area and a second area of the portion of the native tissue, the first area having a first area density greater than a second area density of the second area, the patient-specific three dimensional replica being a tangible representation of at least a portion of native tissue, the patient-specific three dimensional replica being unitarily formed.

25. The three-dimensional patient-specific three dimensional model of claim 24, wherein the first area is anatomically different than the second area.

26. The three-dimensional patient-specific three dimensional model of claim 24, wherein the first area of the spine comprises at least one of vertebral bodies, pedicles, and spinal processes, and the second area of the spine comprises at least one of intervertebral disks, spinal nerves, spinal ligaments, and connecting tissue.

27. The three-dimensional patient-specific three dimensional model of claim 24, wherein the first area is made of a first material and the second area is made of a second material that is different from the first material.

28. The three-dimensional patient-specific three dimensional model of claim 24, wherein the three-dimensional unitary replica reflects at least one of patient-specific flexibility and patient-specific movement relative to a portion of the native tissue.

29. The three-dimensional patient-specific three dimensional model of claim 24, further including at least one non-native structure installed at the at least one location of interest to provide clinically useful information to a user.

30. The three-dimensional patient-specific three dimensional model of claim 24, wherein the three-dimensional patient-specific replica of native tissue, assisted by the non-native structure, is configured to induce a corresponding reaction in the three-dimensional replica.
